(19) United States
(12) Patent Application Publication
(10) Pub. No.: US 2018/0329481 A1
(43) Pub. Date: Nov. 15, 2018

(54) Controller Device and System for Virtual and Augmented Reality Systems

(71) Applicant: Interactive Recreation LLC, Dover, DE (US)

(72) Inventors: Thomas E. Bronesky, Chicago, IL (US); Frederic Pinto Bicho, Strasbourg (FR); Herve Brenac, Sanary sur Mer (FR)

(73) Assignee: Interactive Recreation LLC

(21) Appl. No.: 15/593,318

(22) Filed: May 11, 2017

(51) Int. Cl. G06F 3/01; G06F 3/0346; G06F 3/038; G06F 1/16

(52) U.S. Cl. CPC G06F 3/011; G06F 3/0346; G06F 3/017; G06F 1/163; G06F 3/0383

(57) ABSTRACT

A controller device for interacting in a virtual environment includes a wristband configured to be worn by a user, a body releasably secured to the wristband, an inertial measurement unit (IMU) positioned within the body, a processor in communication with the IMU positioned within the body and in communication with the virtual environment, and a memory in communication with the processor. The memory includes instructions that, when executed by the processor, cause it to determine that the body is in a resting position, detect, by the IMU, a first rotation of the body in a first direction to a first position, and detect, by the IMU, a second rotation of the body in a second direction to a second position. The first and second rotations of the body correspond to first and second actions within the virtual environment.

### BACKGROUND OF THE INVENTION

The present subject matter relates generally to a device for tracking body movement in virtual and augmented reality systems. More specifically, the present invention relates to a wireless, wearable device which is compatible in a plurality of augmented and virtual reality environments.

Technological innovation allows for a more expansive look into our own world, but also for interconnection into other locations, creations, and environments with virtual reality (VR) and augmented reality (AR). Both AR and VR technologies overlay computer-generated environments onto a wearer-controlled platform, either through a standalone unit connected to their head in a mask or goggle-based embodiment (Google Glass, AR; Oculus Rift and Playstation, VR) or via an existing piece of hardware (Pokémon GO! for mobile devices, AR; Google Daydream View, VR).

Use of the existing AR and VR technologies is severely handicapped. VR headsets allow users to see exclusively a virtual world, but resultantly block out external real-world input such as user limbs and clothing, or the surrounding area in which the VR is being used. AR technologies face similar problems; though the augmented environment is overlaid atop the real-world in the user's view, the two worlds tend to be exclusive; hand-gestures, for example, visible on the AR receiver, do nothing in the virtual world. A user may have, at any given time, an internet connected smartphone, tablet, smartwatch, PC, and television, but none of these necessarily interact with the augmented environment.

Setup and use of the VR and AR peripherals can be further complicating. Some VR modules (PlayStation VR, i.e.) require specific Playstation hardware; Oculus Rift only runs on Windows-based operating systems, alienating users of MacOS or Linux. A lack of cross-compatibility inhibits technological innovation in the field.

Additionally, both VR and AR headsets are power-hungry, necessitating short play sessions or cumbersome battery backs which severely limit the distance a user can travel away from a power source.

Further, there is a deficiency in the art with regards to positioning a user in space, particularly in the absence of “virtualizing” (or making digital) a certain room or space. In the absence of autonomous geo-positioning, a user engaged in a virtual reality environment will be entirely disconnected from their surrounding room.

Additional issues exist with regards to data privacy and security within the “Internet of Things.” Increasingly, users who engage in online behavior must choose between convenience and privacy. As an increasing number of devices—including televisions, washing machines, and microwaves—become internet-capable and network into the Internet of Things, the concerns of privacy become all the more pressing.

Accordingly, there is a need for a wearable wireless device which is cross-compatible with both virtual reality and augmented reality environments, as described herein.

### BRIEF SUMMARY OF THE INVENTION

To meet the needs described above and others, the present disclosure provides a wearable wireless device which is cross-compatible with both virtual reality and augmented reality environments.

By providing a controller that allows compatibility for all platforms directed to both virtual reality and augmented reality, the presented invention is more versatile and functional than a device limited to only one such technology.

In one example, the controller is wrist-mounted and controlled by simple hand and wrist motions and gestures. The present invention measures the pitch and roll of the user's wrist along with motion along three axes to generate and monitor a position in space, applicable in both AR and VR contexts.

An advantage of the invention is the interaction with the virtual space. The device allows for precise indoor positioning without the need for an additional device, because it allows detection of movement if the hand or wrist is outside the motion area and computation of a new motion area based on the position.

A further advantage of the invention is the ability to map modes onto custom actions in virtual space. In one embodiment, the device can detect wrist rotations (clockwise, counterclockwise) and automatically correlate those movements into modes which map onto custom actions in virtual space, including drag, drop, pull, push, and click.

An object of the invention is to provide a solution to the incompatibility of the present technology in both VR and AR spaces. The present invention provides an oriented multiplatform VR/AR/PC/IoT device which provides cross-platform functionality to a plurality of inputs and digital environments.

Another object of the invention is to provide a solution to the lack of geo-localization indoors, where the majority of VR and AR activities occur. The localization uses an algorithm to determine the precise location of the user to 1 meter. Such geo-localization allows for a virtualized room environment, where real world objects are virtualized so as to be relevant in the AR or VR environment.

An advantage of the invention is that it provides an internal battery in the main body, coupled with an external battery stored in its interchangeable bracelet. This setup allows the invention to avoid the aforementioned issue of large power draw and necessity of proximity to an outlet, because the external bracelet-based batteries can be interchanged so that user may continue using the device for longer than a single battery-charge would last. In the primary embodiment, the wireless peripheral is capable of accepting charge via near field communications (NFC) technology. The battery units are also contained within the bracelet but connected so as to provide the power of a large, unified battery.

A further advantage of the invention is that it provides a peripheral to point and interact in VR and AR environments. The peripheral and its interface function across all operating systems (Windows, Linux, Mac OS, Android, iPhone, etc.) and other connected peripherals. In one embodiment, an API allows the transcription of movements of the user and the rotations of the wrist that is bearing the device to command and control in digital environments, which allows full interaction through simple wrist and hand motion. Possible traceable and configurable movements include click, point, double click, select, drag, direct, etc.) in the digital environment.

Another advantage of the invention is that it provides an authentication API to serve as a configurable access control device and remote recognition. Such an authentication module and programmable identification protocol allows for increased data security and privacy despite the networked behavior of the device. In the primary embodiment, this authentication module is linked to a configurable authentication protocol and a dedicated user authentication microchip linked to all digital environments and platforms. This allows the invention to function in a plurality of digital spaces including VR and AR with a single authentication module.

An additional advantage of the invention is the availability of communication inputs to control various tasks. For example, a preconfigured calibration gesture such as a left or right hand swipe up or down could trigger a certain input. In a suggested embodiment, a voice keyword could trigger a preconfigured activation action. Such inputs are controlled by a communication module contained inside the main unit.

A further advantage of the present invention is that it allows for data storage directly integrated into the body of the invention. Having integrated data storage allows the invention to function wirelessly without the need to add additional peripherals or data storage drives.

Another advantage of the invention is the availability of ports on the main body of the device. Extension ports are included to add further evolutions of the invention without changing the initial device. In one embodiment, the main unit is a USB-key that is encased in the silicone wristband for comfort while wearing and protection of the electronics. The built-in USB-key mechanic also allows for connection via port to any computer or IOT device to configure and program an interaction between wristband and operating system. In an embodiment, the unit is also wireless for remote data transmission.

An additional advantage of the invention is its electronic makeup which allows for numerous uses. In one embodiment, the invention includes a storage module, a memory module, an encryption module, a communication module, a processor, a microphone, an LED, an extension port, a speaker, a button, and an inertial measurement unit.

Another advantage is the ability to modularize the invention. One such module that can be added in one embodiment is the smart clip unit, which includes an interchangeable dial screen to customize the visual display on the bracelet itself.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic view of the controller device of the present application connected to other devices.

FIG. 2 is a perspective view of the controller device of the present application.

FIG. 3 is diagram of the components of the controller device of FIG. 2.

FIG. 4 is a diagram of the outer surface of the controller device of FIG. 2.

FIGS. 5A and 5B are plan and side views of the interchangeable screen of a further embodiment of the controller device of the present application.

FIG. 6 is a schematic of a wristband of the controller device of FIG. 2.

FIG. 7 is a plan view of a connector between the wristband and the body of the controller device of FIG. 2.

FIG. 8 is a flowchart detailing the controller device-peripheral device interaction of the controller device of FIG. 2.

FIG. 9 is a flowchart detailing the calibration of the controller device of FIG. 2.

FIGS. 10A and 10B illustrate the controller device being used with a virtual reality device and an augmented reality device, respectively.

FIG. 11 is a flowchart detailing the positioning and actions of the controller device of FIG. 2.

### DETAILED DESCRIPTION OF THE INVENTION

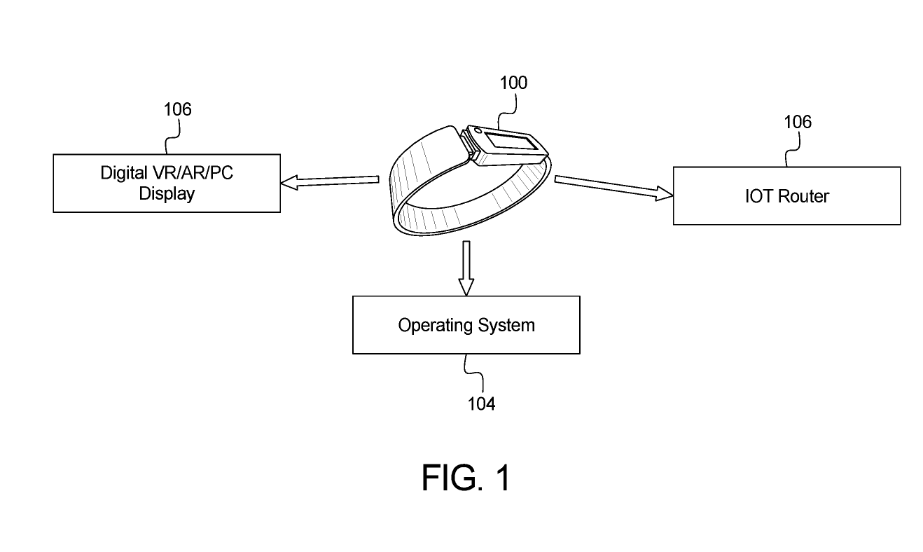

Referring to FIG. 1, the controller device 100 of the present application provides a pointing peripheral and interaction controller for virtual and augmented reality systems 102, all computer, mobile phone, and other device operating systems 104 (Windows, Linux, Mac OS, Android, iPhone, etc.), engines (Unity, Unreal, etc.), and all connected peripheral devices 106. The controller device 100 enables a user to interact with his surroundings by tracking movement and interacting with all existing digital platforms 102, providing geopositioning within 1 m., providing secured authentication as the device connects to nearby devices, and providing a secured data storage. Further, the controller device 100 is modular in that it can be upgraded to adapt to future systems of exploitation via wireless remote motions and actions.

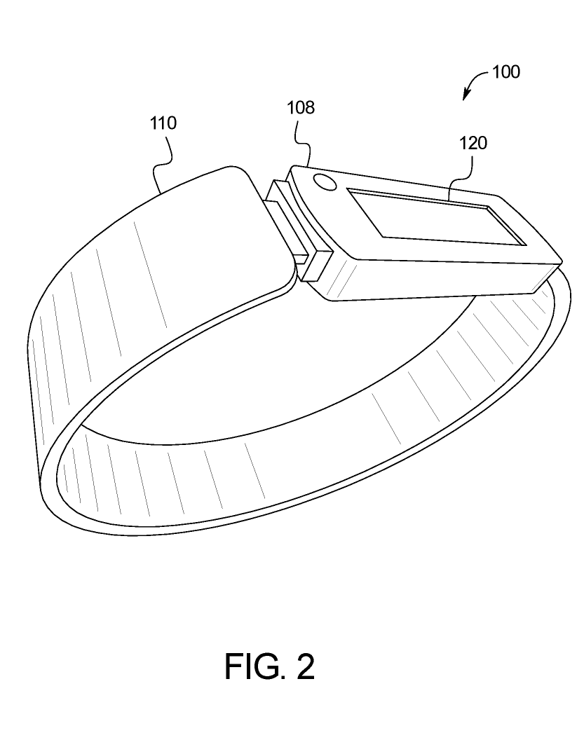

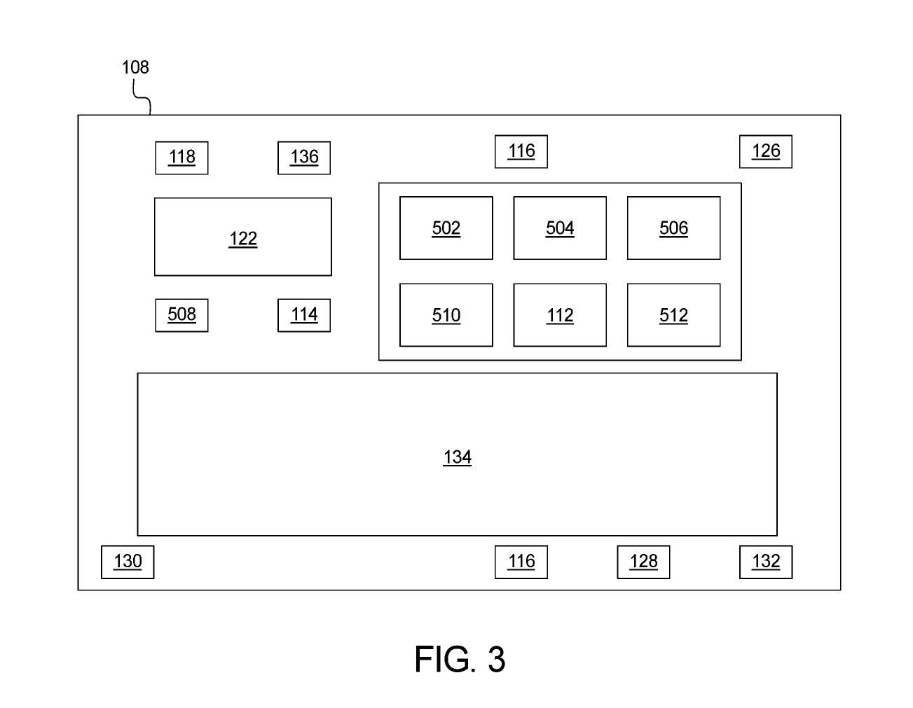

FIG. 2 illustrates an example of a virtual reality controller device 100 of the present application. As shown in FIG. 2, the controller device 100 includes a body 108 coupled to a wristband 110. Referring to FIG. 3, the body 108 houses a processor 112 with a USB flash drive 114 on a USB connection. In one embodiment, the USB flash drive 114 provides 64 GB of data storage. The controller device 100 can connect to any computer 104 or peripheral device 106 to configure and program the interactions between the controller device 100 and the operating system of the computer 104 or device 106. A wireless communication subsystem 118 on the controller device 100 enables remote data transmission to computers 104, virtual/augmented reality devices 102, and peripheral devices 106. In a preferred embodiment, the body 110 is securely enclosed within a silicone casing 120 (FIG. 2) so as to prevent the potential for tampering with the components.

The body 108 also includes an inertial measurement unit (IMU) 122 to detect movement of the device 100. The IMU 122 includes an accelerometer and a gyroscope to measures the velocity, the direction, the location of the movement of the controller device 100. The body 108 also includes one or more extension ports 116 to enable upgrades of programming of the controller device.

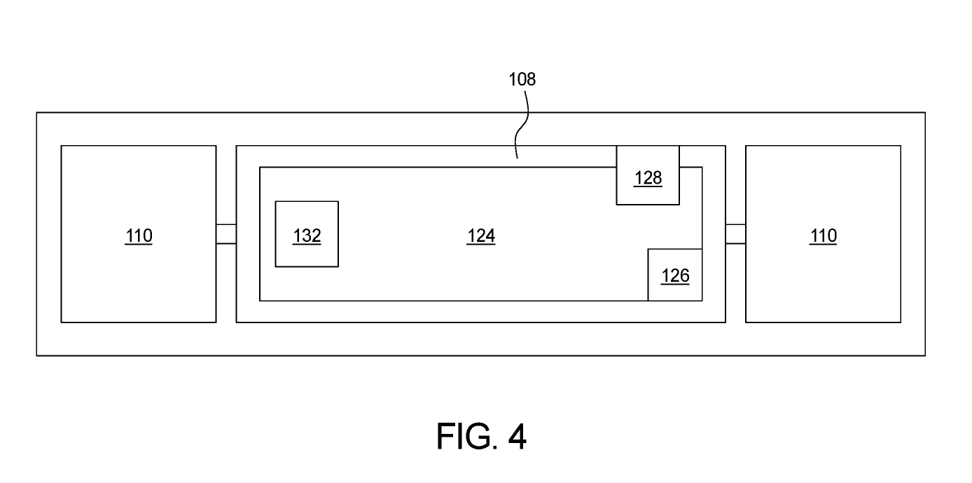

On an exposed surface 124 of the body 108 illustrated in FIG. 4, a light 126 such as a three-state LED light that communicates through flashing to the user. A push button 128 communicates with the processor 112 to activate the controller device 100 and to connect the controller device 100 to operating systems 104 and/or peripheral devices 106. A microphone 130 is also in communication with the processor 112, allowing the controller device 100 to be voice activated. Voice communications from connected operating systems 104, peripheral devices 106, and/or virtual/augmented systems 102 may be transmitted through the controller device 100 and emitted from a speaker 132 on the body 108.

Operation of the controller device may be controlled by the push button 128 or the microphone 130. Compression of the push button 128 may correspond to activation or deactivation of the controller device 100 or synchronization with peripheral devices 106, depending on the duration and number of compressions. For example, two, three, and four short compressions (less than one second) may correspond to connection to a first peripheral device 106, a second peripheral device 106, and a third peripheral device 106, respectively. A three-second compression may activate the controller device 100. A five-second compression may deactivate the controller device 100.

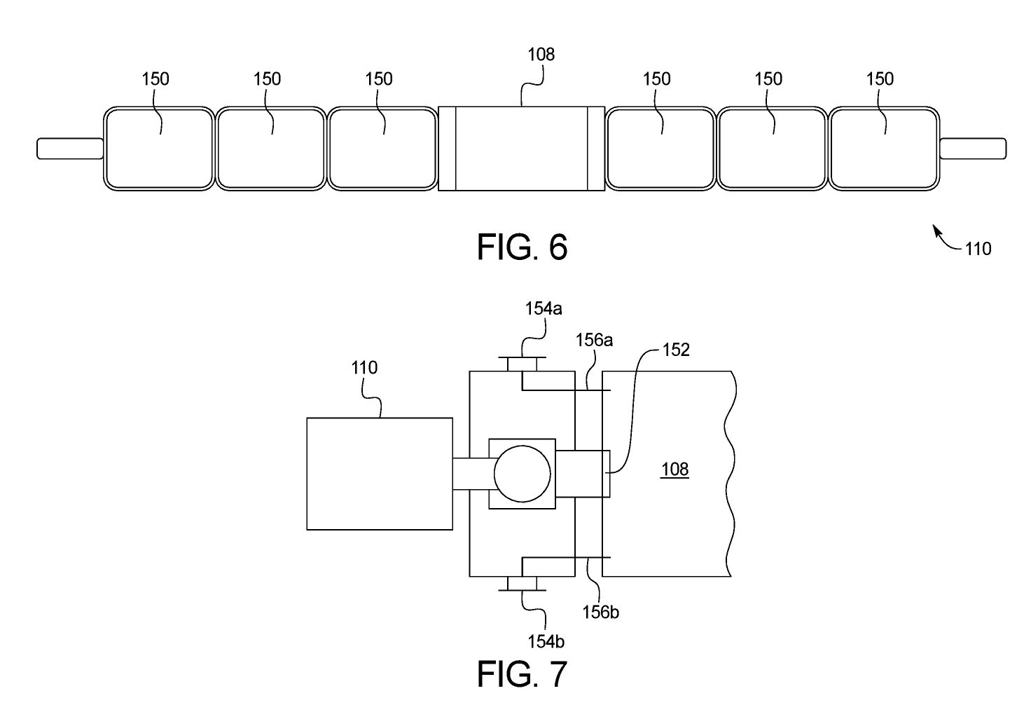

The controller device 100 is powered by an internal battery 134 housed within the body 108 and coupled to an external battery 150 (FIG. 6) located in the wristband 110. A near field communication (NFC) box 136 within the body 108 enables wireless charging of the device 100 when positioned near a wireless charger. Using NFC wireless encrypted contact, the NFC box 136 enables the controller device 100 to trigger specific actions such as opening a door when the control device 100 is located within a specific distance, validating access/checkpoints, and making micropayments.

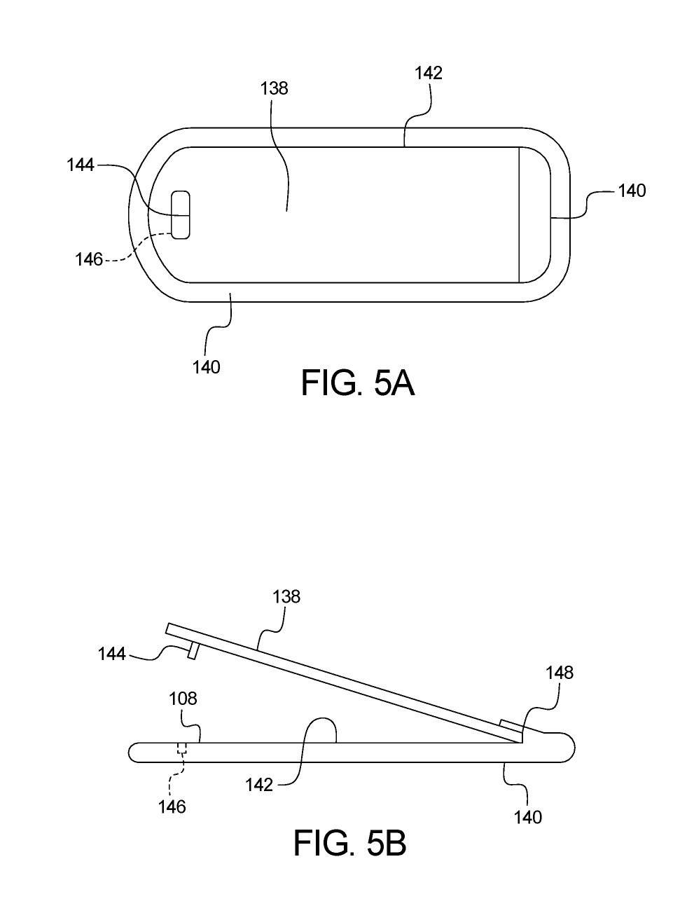

As shown in FIGS. 5A and 5B, an interchangeable screen 138 may be secured to the outer surface 124 of the body 108. A shell 140 is shaped to securely contain the body 108. The outer surface 124 of the body 108 is exposed through an opening 142 of the shell. The screen 138 includes a protrusion 144 that is received by a cavity 146 within the shell 140. At an end opposite of the cavity 146, a shoulder surface 148 extends slightly over the opening 142. During use, the screen 138 is positioned under the shoulder surface 148 and the protrusion 144 is positioned in the cavity 146 in order to secure the screen 138 within the opening 142 of the shell 140. The screen 128 clips onto the body 108 for customization of the visual display on the controller device 100. The interchangeable screen 138 may provide a digital watch, a smart data watch, or other informational presentation. In other embodiments, the screen 138 may include an additional battery such as a photovoltaic or standard battery. In still other embodiments, the screen 138 may provide for customized security and protection of the controller device.

Referring to FIGS. 2 and 6, the wristband 110 can be formed from any structural material appropriate for enclosing the internal elements. For example, the wristband 110 may be made from silicone, although numerous known substitutes may be used, as will be recognized by those skilled in the art. The wristband 110 is replaceable, as the body 108 may be disconnected therefrom. In the embodiment illustrated in FIG. 6, a plurality of micro flexible battery components 150 may be assembled to form the wristband 110. In this embodiment, the micro flexible battery components 150 are modular and contained within the silicone wristband 110 of the controller device 100. Once the battery components 150 lose their charge, the body 108 may be disconnected from the used wristband 110 and secured to a new, fully charged wristband 110. Additionally, another embodiment of the micro flexible battery components 150 includes metal plating of each battery for heat dissipation and the ability for the bracelet to conform to the shape of the wrist. The invention moreover includes a battery connection system which allows a plurality of battery units working together to provide the unit power.

Referring to FIG. 7, a connector 152 allows the body 108 to be easily secured to and released from the wristband 110. The connector 152 includes first and second ejection buttons 154a, 154b on opposing sides thereof that are in communication with first and second latches 156a, 156b, respectively, that latch onto the body 108. The application of pressure to the first and second ejection buttons 154a, 154b compresses first and second latches 156a, 156b toward one another and release the attachment to the body 108. The wristband 110 may include first and second connectors 152 at each end of the body 108.

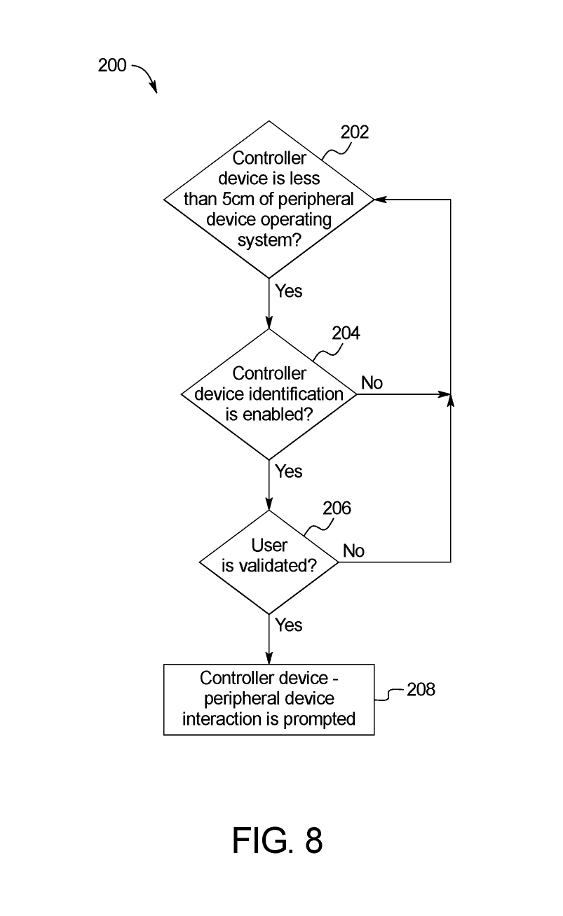

FIG. 8 illustrates the methodology followed by the controller device 100 to interact with a peripheral device 106. In the illustrated embodiment, the controller device 100 emits a signal that is detected by a peripheral device 106. The interaction between the controller device 100 and the peripheral device 106 may depend on factors such as the synchronization of the device, the signal strength, the accelerometers, and a software patch. The controller device 100 is programmed to execute a router interaction method 200 as illustrated in FIG. 8. In the first step 202, the controller device 100 confirms that the peripheral device is within about 5 cm of the peripheral device 106. In one embodiment, the distance between the controller device 100 and the peripheral device 106 is estimated by the signal attenuation. Once confirmed, the controller device 100 enables the controller device identification in step 204. If the controller device identification is not enabled, the controller device reverts to the step 202. If the controller device identification is enabled, the controller device 100 then validates the user in step 206. If the user is not validated, the controller device 100 reverts again to the first step 202. After a number of preconfigured unsuccessful attempts, the controller device 100 sends a message to the user by a preconfigured means such as a phone call, a text message, or an email. If the user is validated, interaction with the peripheral device 106 is prompted in step 208. For example, if the peripheral device is a door with an electronic lock, the connection of the controller device to the door may cause the door to unlock. Other interactions include accessing a peripheral device, accessing a vending machine access, and customer fidelity program data storage.

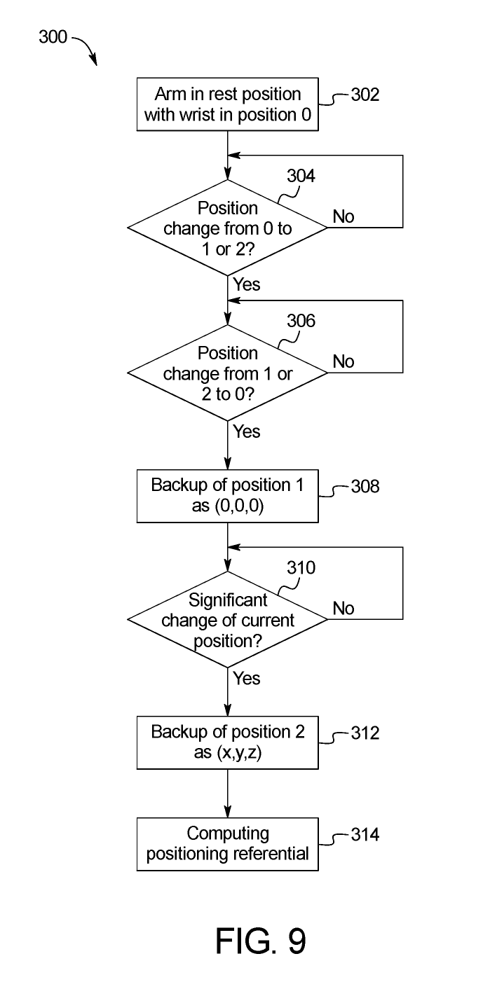

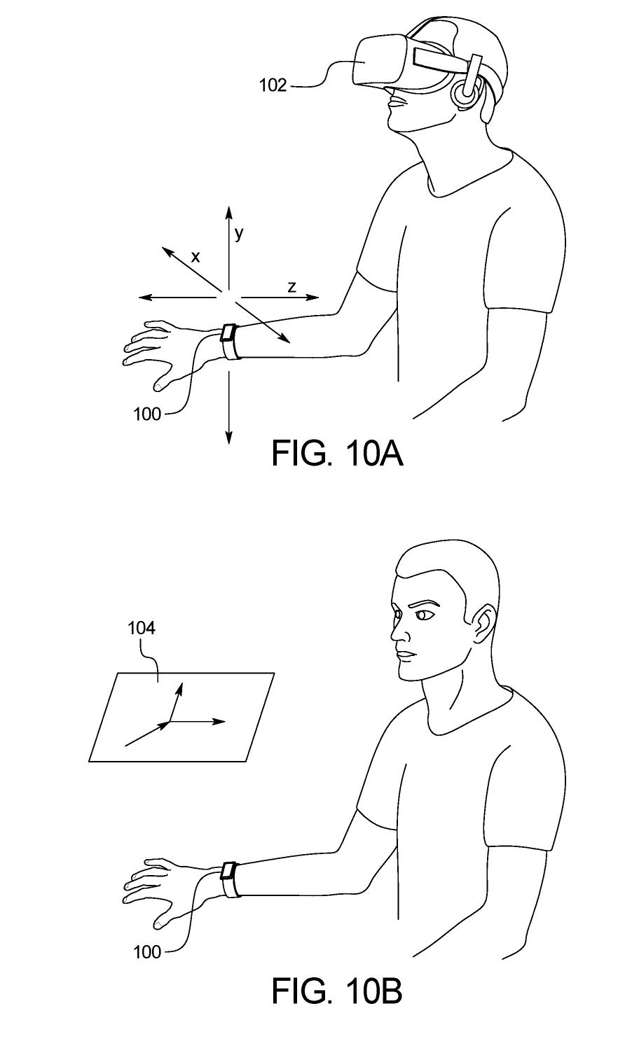

Referring to FIG. 9, the controller device 100 is programmed to transcribe specific wrist rotations as specific commands and control actions in digital environments to interact with all platforms. The controller device 100 is calibrated by associating specific motions with specific modes according to the calibration method 300 as set forth in FIG. 9. The calibration method 300 can be used when calibrating with a VR/AR device 102 as shown in FIG. 10A as well as a computer operating system 104 as shown in FIG. 10B. If the controller device is being used with an AR/VR headset 102, the position of the controller device 100 is indicated in a virtual display such as a VR or AR headset, a computer screen, or a VR-enabled phone, as an action symbol such as a cursor. If the hand/wrist motion is outside of the motion area of the AR/VR headset, a movement is detected and a new motion area range is computed. This allows for precise positioning without any additional components.

Calibration of the controller device 100 simply requires the performance of specific wrist movements. The IMU 122 measures the movement of the controller device 100, and the processor 112 transmits that information to the operating system 104 and/or the VR/AR device 102.

FIG. 9 illustrates the steps undertaken by the processor 112 on the controller device 100 during calibration on the platform. In the first step 302, the wrist is positioned flat with the controller device 100 atop the wrist in a resting position. The platform automatically recognizes that the controller device 100 in Mode 0. In the next step 304, the wrist is rotated about 30 degrees in a clockwise direction from position 0 to position 1 or in a counterclockwise direction from position 0 to position 2. The platform automatically recognizes the controller device 100 moving clockwise or counterclockwise from Mode 0 to Mode 1 or Mode 2, respectively. In the subsequent step 306, the wrist is then returned to the resting position by going counterclockwise or clockwise from Mode 1 or Mode 2, respectively, to Mode 0. With the wrist in the rest position, the platform recognizes that the controller device 100 is in Mode 0 and generates a backup of position 0 in step 308. In the subsequent step 310, the wristband is moved into a new position significantly different from the positions of Modes 0, 1, and 2, and then computes position 2. The platform then generates a backup of position 2 in step 312, and then computes a positioning referential in step 314.

In the further step, the wrist is rotated from the rest position to position 1 at about 30 degrees, returned to the rest position, and again rotated to position 1 within a short duration of time in Mode 3 such that the quick and short rotations correspond to a double click within the platform. Mode 3 is a combination that recognizes the double movement as a single action within a single time frame. An optional additional step is rotation of the controller device as the controller device moves along a vertical axis to generate a custom action such as zooming in/out, dragging a window, or clicking on a virtual button. In each case, every mode is mapped to a custom action. In a virtual space, each action moves the cursor to enable the cursor to drag, drop, pull, push, and click on items.

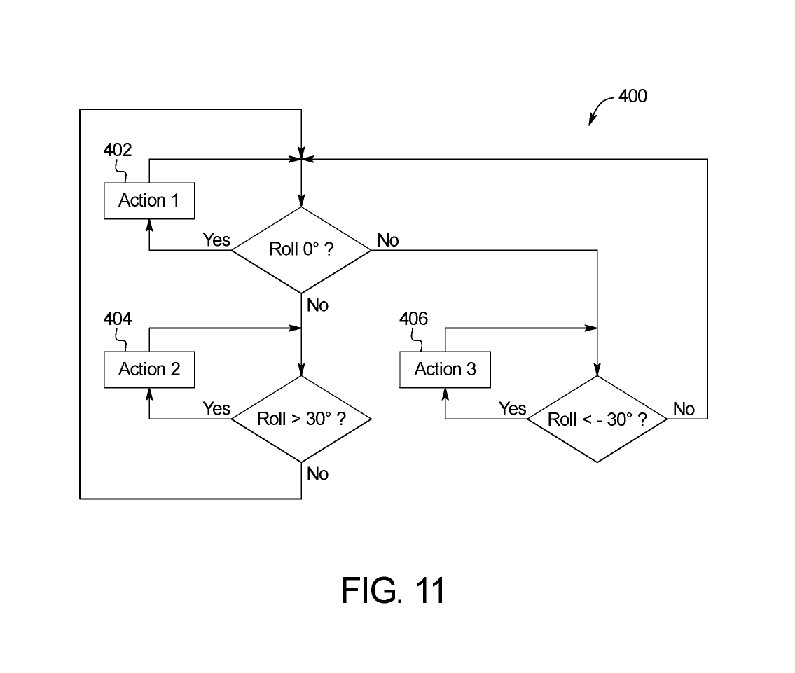

FIG. 11 illustrates the positioning and actions process 400 undertaken by the user during the calibration process and all subsequent actions, such as grab, pull, drag, and click. In the first step 402, the user positions the wrist in the resting position in action 1. If the user rotates the wrist 30 degrees, the user undertakes action 2 in step 404. When the user rotates the wrist 30 degrees in the counterclockwise direction, the user undertakes action 3 in step 406. Each of actions 1, 2, and 3 enable the controller device 100 to be calibrated. Actions 1, 2, and 3 also allow the device 100 to communicate direct actions taken in a virtual or digital environment.

Periodic sampling provided by the accelerometer enables the controller device to provide a precision location by capturing a plurality of data points that represent a continuous signal. Each movement of the wrist provides an acceleration data point. In one example, three accelerations may be derived from four samples from the accelerometer, and two positions by successive integrations may be derived from the three accelerations. Ultimately a variation of a position is derived from the two positions. The variations in the initialized system with a position (0, 0, 0) from the previous steps allow the controller device to determine a position of the controller device and therefore the user within a space. Theoretically, the periodic sampling provides for continual updating of and adjusting the precise location of the wristband as the wristband is constantly in motion.

Referring to FIG. 3, the processor of the controller device 100 includes a plurality of modules 500 that act independently as well as cooperatively in order to provide a variety of functionalities including secure authentication and encryption processes. The program instructions for the various functions are stored on a memory 502 within a memory module 504. A storage module 506 is provided for the user to upload and add specific functions separate and apart from the functions provided by the controller device 100 itself. For example, programs related to micropayments, a geolocation device, or access to parts of the hotel may be stored on the storage module. These programs operate separate and apart from the authentication and encryption processes.

Regarding the authentication process, each controller device 100 has a dedicated security chip 508 that is registered with the manufacturing company and not user-modifiable so that the manufacturing company maintains the confidentiality and privacy of the customer data. The inability for a user to modify the security chip 508 improves security by making the chip 508 difficult to alter or replace. Users can add certain parameters to the secured chip 508 by going through the programmable identification protocol to provide a unique ID for each controller device 100 for a specific access granted process, which will require coordination between the memory module 504, the storage module 506, and an encryption module 510. The encryption module 510 provides full encryption for identification purposes.

A communications module 512 allows for the integration of the controller device 100 with the VR/AR devices 102, the computer systems 104, and the peripheral devices 106 through Bluetooth and Wi-Fi. Programming on the communications module 512 implements usage of voice recognition through the microphone and the speakers.

It should be noted that various changes and modifications to the presently preferred embodiments described herein will be apparent to those skilled in the art. Such changes and modifications may be made without departing from the spirit and scope of the present invention and without diminishing its attendant advantages.

We claim:

1. A controller device for interacting in a virtual environment comprising:
a wristband configured to be worn by a user;
a body releasably secured to the wristband;
an inertial measurement unit (IMU) positioned within the body;
a processor in communication with the IMU positioned within the body and in communication with the virtual environment; and
a memory in communication with the processor, the memory including instructions that, when executed by the processor, cause it to:
determine that the body is in a resting position;
detect, by the IMU, a first rotation of the body in a first direction to a first position;
detect, by the IMU, a second rotation of the body in a second direction to a second position;
wherein the first and second rotations of the body correspond to first and second actions within the virtual environment.

2. The controller device of claim 1, wherein during the first rotation, the body rotates about 30 degrees from the resting position.

3. The controller device of claim 1, wherein during the second rotation, the body rotates about 30 degrees from the resting position.

4. The controller device of claim 1, wherein the processor further detects, by the IMU, a double rotation of the body in one of the first and second directions, wherein the double rotation of the body corresponds to a third action within the virtual environment.

5. The controller device of claim 1, wherein the first action within the virtual environment is one of tracking, clicking, dragging, and pulling of a mouse cursor.

6. The controller device of claim 1, further comprising an accelerometer positioned within the body, wherein the processor further determines, by the accelerometer, a plurality of acceleration data points and determines a position of the body based on the plurality of acceleration data points.

7. The controller device of claim 6, wherein the processor derives a plurality of accelerations from the plurality of acceleration points and derives a plurality of positions from the plurality of accelerations.

8. The controller device of claim 6, wherein the processor continually derives a plurality of accelerations from the plurality of acceleration points and continually derives a plurality of positions from the plurality of accelerations.

9. The controller device of claim 8, wherein the processor provides geopositioning of the body within about 1 m.

10. The controller device of claim 1, wherein the processor emits a signal detected by and allows access to a peripheral device.

11. The controller device of claim 10, wherein the processor validates the user in connection with the peripheral device.

12. A controller device for interacting in a virtual environment comprising:
a wristband configured to be worn by a user;
a body releasably secured to the wristband;
an internal battery positioned within the body;
an inertial measurement unit (IMU) positioned within the body;
an accelerometer positioned within the body; and
a processor in communication with the IMU positioned within the body and in communication with the virtual environment,
wherein rotation of the body in a first direction causes a first action in the virtual environment, and wherein rotation of the body in a second direction opposite of the first direction causes a second action in the virtual environment.

13. The controller device of claim 12, wherein the body comprises silicone.

14. The controller device of claim 12, wherein the wristband includes a plurality of external batteries.

15. The controller device of claim 14, wherein the wristband comprises silicone, and wherein each of the external batteries is a micro flexible battery embedded within the silicone.

16. The controller device of claim 12, wherein the body connects to the wristband at first and second opposing ends of the body, and wherein the controller device further comprises first and second ejection buttons at the first and second opposing ends of the body to allow for release of the body from the wristband.

17. The controller device of claim 12, wherein the controller device includes a memory of at least 64 GB of data storage and an extension port for receiving additional memory.

18. The controller device of claim 12, wherein the extension port is a universal serial bus port.

19. The controller device of claim 12, further comprising an interchangeable screen secured to the body.
